(19) United States
(12) Patent Application Publication
(10) Pub. No.: US 2024/0061941 A1
(43) Pub. Date: Feb. 22, 2024

(54) Distribution of Secure Data for Networked Transactions

(71) Applicant: ServiceNow, Inc., Santa Clara, CA (US)

(72) Inventors: Adrian Spalka, San Francisco, CA (US); Saswat Nayak, Santa Clara, CA (US); Pierre Rohel, San Francisco, CA (US)

(21) Appl. No.: 17/892,657

(22) Filed: Aug. 22, 2022

(51) Int. Cl. G06F 21/60; G06F 21/62; H04L 9/06; H04L 9/08

(52) U.S. Cl. CPC G06F 21/602; G06F 21/6227; H04L 9/0643; H04L 9/0822

(57) ABSTRACT

In an embodiment, persistent storage contains one or more cryptographic keys. One or more processors may be configured to perform operations comprising: receiving a request for an encrypted record stored within a computational instance, wherein the request includes a plaintext value related to the encrypted record; obtaining a hash value by applying a hash function to the plaintext value; transmitting, to the computational instance, the hash value; receiving, from the computational instance, the encrypted record, wherein the encrypted record includes one or more encrypted values; obtaining an unencrypted version of the encrypted record by applying a cryptographic function to the encrypted record, wherein applying the cryptographic function includes use of a cryptographic key of the one or more cryptographic keys; and transmitting at least part of the unencrypted version of the encrypted record.

### BACKGROUND

Many entities have the need to store large numbers of records that contain sensitive information. This information could be, but is not limited to, personally identifying information (PII), access credentials, financial information, health information, and so on. Thus, being able to store this information securely but still be able to use it in networked transactions can be of paramount importance. In addition, these entities also find it advantageous to outsource or distributed the storage of records to a third party that operates databases and/or datacenters that are robust, hardened, and highly available. But doing so in an efficient fashion that provides the third party only with encrypted versions of the sensitive information—and does not allow the third party to have access to unencrypted versions thereof—has proven challenging.

### SUMMARY

The embodiments herein overcome these and possibly other drawbacks to previous systems, devices, and methods by providing computational instance resources (e.g., processing and database nodes) in a remote network management platform to store encrypted versions of sensitive information. Notably, the key or keys needed to decrypt these records are not stored in and are not accessible to the remote network management platform. Thus, the sensitive information is secured, in that it cannot be derived by humans affiliated with the remote network management platform or software executing thereon.

On the other hand, the individual records can be accessed remotely by an entity. If the entity has the appropriate key or keys, it may be able to retrieve and decrypt the sensitive information as needed (e.g. to edit it or use it as part of a networked transaction). Provided that decryption keys are only in the hands of authorized entities, access by malicious or other unauthorized entities does not compromise a record's confidentiality. Advantageously, this arrangement allows the offloading of storage infrastructure to the third party without sacrificing the confidentiality, authenticity, or integrity of the sensitive information maintained therein. Such a system facilitates numerous types of networked transactions and workflows.

Accordingly, a first example embodiment may involve receiving, by one or more processors disposed within a network and from a client device, a request for an encrypted record stored within a computational instance, wherein the request includes a plaintext value related to the encrypted record, wherein the computational instance is physically distinct from the network, and wherein persistent storage disposed within the network contains one or more cryptographic keys; obtaining a hash value by applying a hash function to the plaintext value; transmitting, to the computational instance, the hash value; receiving, from the computational instance, the encrypted record, wherein the encrypted record includes one or more encrypted values; obtaining an unencrypted version of the encrypted record by applying a cryptographic function to the encrypted record, wherein applying the cryptographic function includes use of a cryptographic key of the one or more cryptographic keys; and transmitting, to the client device, at least part of the unencrypted version of the encrypted record.

A second example embodiment may involve receiving, by one or more processors disposed within a network and from a client device, an authorization request, wherein the authorization request includes sensitive information, and wherein persistent storage disposed within the network contains one or more cryptographic keys; obtaining an encrypted version of the sensitive information by applying a cryptographic function to the sensitive information, wherein applying the cryptographic function includes use of a cryptographic key of the one or more cryptographic keys; transmitting, to a computational instance, the encrypted version of the sensitive information, wherein the computational instance is physically distinct from the network; and receiving, from the computational instance, a first acknowledgment that the encrypted version of the sensitive information has been stored.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts an example architecture for secure data distribution, in accordance with example embodiments.

FIG. 7 depicts a procedure for remote access to encrypted records, in accordance with example embodiments.

FIG. 8 depicts a procedure for logging transactions in encrypted records, in accordance with example embodiments.

FIG. 9 is a flow chart, in accordance with example embodiments.

FIG. 10 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

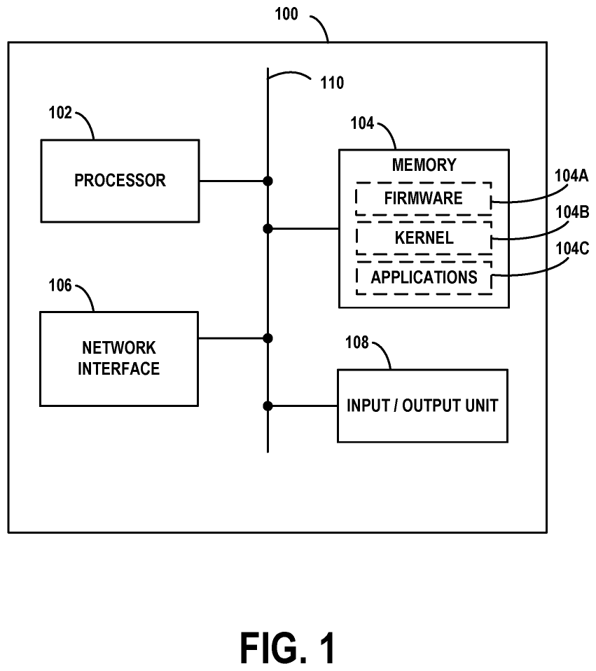

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

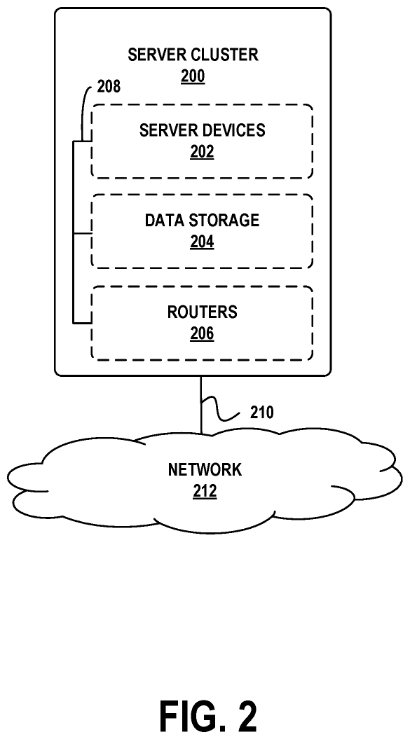

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, the eXtensible Markup Language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

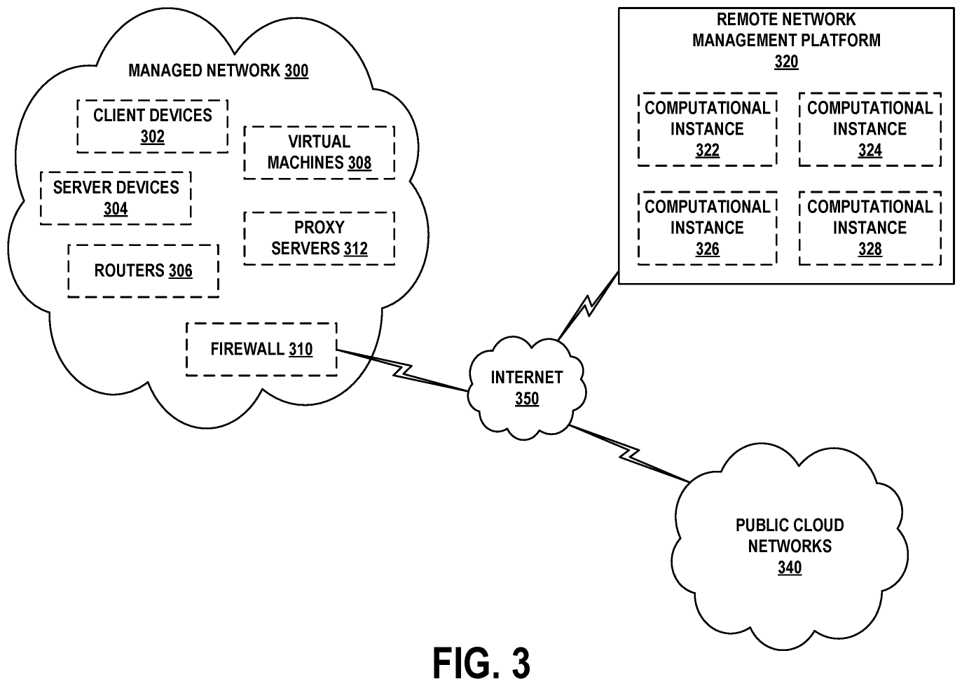

FIG. 3 depicts a remote network management architecture, in accordance with example embodiments. This architecture includes three main components—managed network 300, remote network management platform 320, and public cloud networks 340—all connected by way of Internet 350.

A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

D. Communication Support and Other Operations

Internet 350 may represent a portion of the global Internet. However, Internet 350 may alternatively represent a different type of network, such as a private wide-area or local-area packet-switched network.

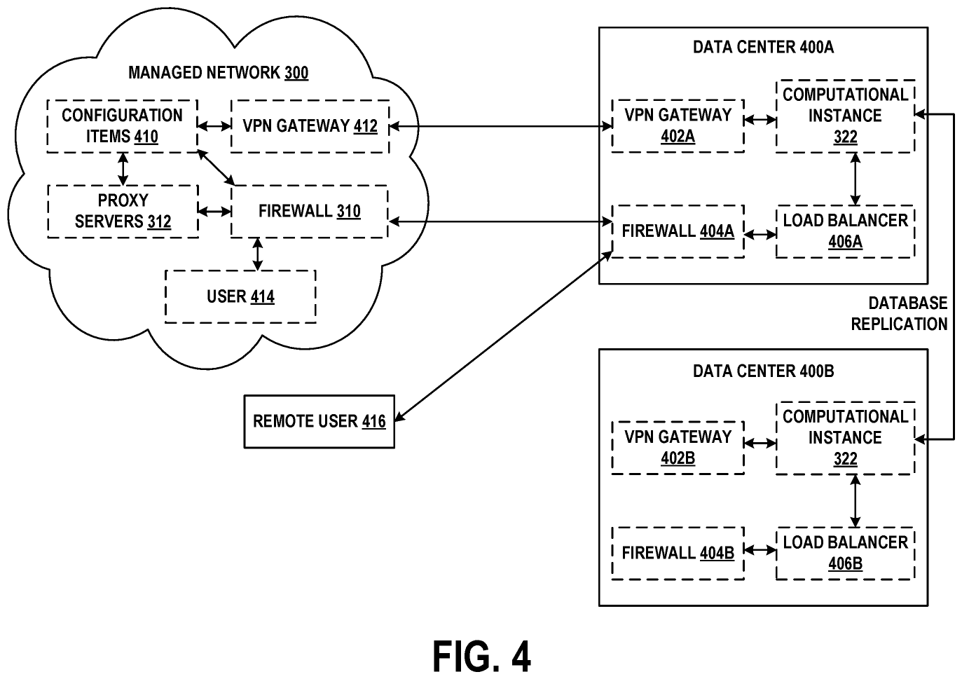

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### IV. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of each device, component, application, and service may be referred to as a configuration item. The process of determining the configuration items and relationships within managed network 300 is referred to as discovery, and may be facilitated at least in part by proxy servers 312. Representations of configuration items and relationships are stored in a CMDB.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

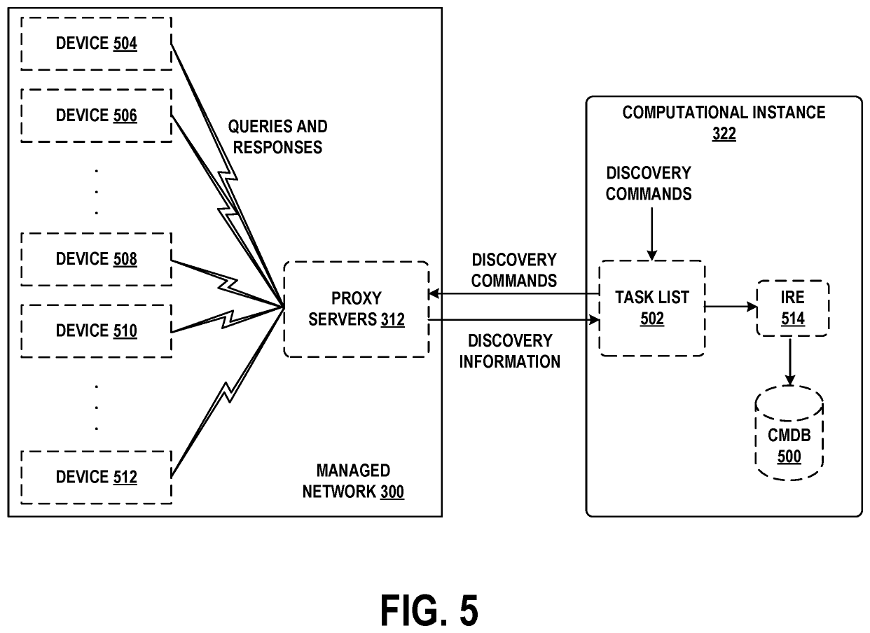

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery—horizontal and vertical (top-down). Each are discussed below.

A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases—under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### V. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VI. Secure Distributed Architectures

The remote network management platforms described herein may be adapted to securely store various types of sensitive information. For example, personal identifiable information (PII) might include names, addresses, email addresses, phone numbers, and various forms of government identifiers (e.g., social security numbers, tax identifiers). Additionally, access credentials, such as userids, passwords, certificates, and so on, are also considered to be sensitive information. Another form of sensitive information is financial in nature, such as bank account numbers, credit or debit card numbers, and credit scores. A further form of sensitive information includes any type of health records, such as medical diagnoses, lab test results, medications or prescriptions, immunization status, surgical records, etc. Other types of sensitive information may exist, such as transaction logs memorializing interactions relating to sensitive information.

Here, it is assumed that sensitive information is stored within discrete records in one or more databases. These records may be spread across one or more tables of such databases. Each record may contain at least one field containing sensitive information. Thus, some or all fields of the records may be encrypted when stored so that the sensitive information is unreadable to anyone who accesses the records without the appropriate decryption key(s), regardless of whether these individuals have innocent or malicious intent. Further, such encryption may protect the sensitive information from malware that is designed to find and disclose unencrypted sensitive information.

But designing, developing, and maintaining a software and hardware infrastructure to achieve these goals is difficult, time-consuming, error-prone, and expensive. For instance, the credit card industry has published a series of security standards relating to securing networks and devices, protecting cardholder data, vulnerability management, access control, testing, and policy maintenance. Most organizations would be hard pressed to develop the expertise and know how to meet these specifications.

In addition to that, the size of databases containing sensitive information can be in the gigabytes or terabytes, and these databases may need to support thousands of accesses (e.g., additions, deletions, and modifications) per second. As some public or private cloud infrastructure providers already have security database architectures that can scale to these requirements, there is little or no need for other organizations to “reinvent the wheel” in this fashion.

Accordingly, the embodiments herein provide mechanisms for distributing records of sensitive information to a third party for secure storage. For example, the sensitive information may be stored in databases of computational instances dedicated to the organizations that own the records. Notably, the key or keys needed to decrypt these records are not stored in and are not accessible to the computational instances. Thus, the sensitive information is secured, in that it cannot be derived by humans affiliated with the remote network management platform or software executing thereon. Doing so lifts an enormous burden off the shoulders of organizations tasked with handling sensitive information. Moreover, incorporating a computational instance into various types of transaction processing can facilitate integration of the transaction into workflows and procedures supported by the remote network management platform (e.g., workflows and procedures related to discovered configuration items).

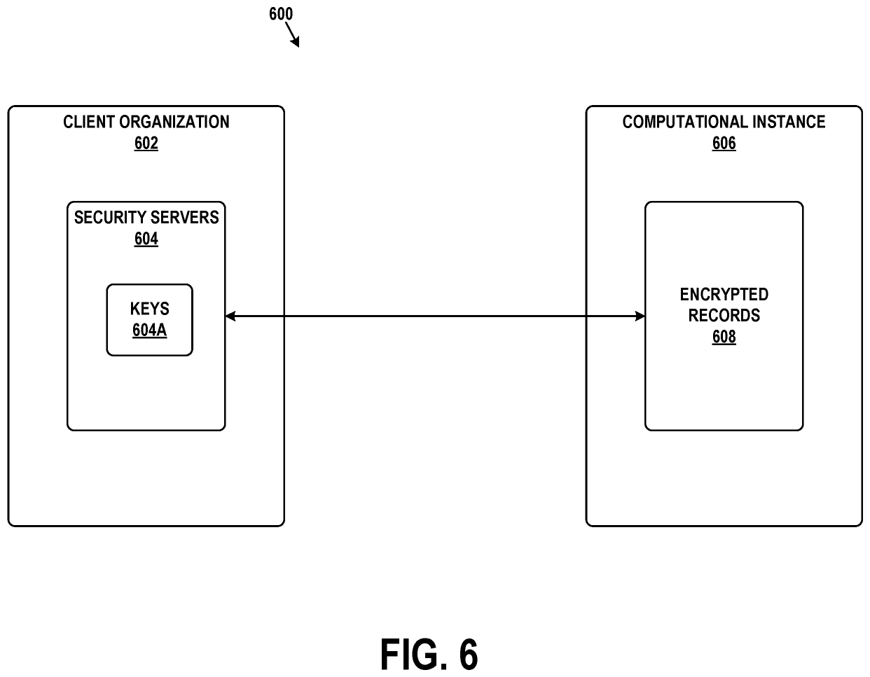

FIG. 6 provides a basic architecture 600 for the embodiments herein, and will be expanded through way of example. Architecture 600 includes client organization 602 and computational instance 606.

Client organization 602 may be one or more networks and/or computational resources operated by an entity that seeks to distribute its sensitive information in a secure fashion. Thus, in some cases, client organization 602 may be a managed network, such as managed network 300. But other possibilities exist. Client organization 602 may include security servers 604 arranged to store keys 604A as well as to perform other functions described herein.

Computational instance 606 may be part of a remote network management platform as described above. In addition to various other functions of a computational instance, computational instance 606 may store encrypted records 608. These records may be maintained in one or more databases. Encrypted records 608 may be written to computational instance 606 by security servers 604. Similarly, copies of encrypted records 608 may be retrieved from computational instance 606 by security servers 604. Security servers 604 may be implemented within proxy servers 312, for example, or with separate physical hardware, virtual machines, or software applications.

It is assumed that encrypted records 608 can be decrypted by keys 604A. Accordingly, keys 604A are not shared with computational instance 606 to prevent individuals or software relating to computational instance 606 from decrypting encrypted records 608. Instead, keys 604A are maintained by security servers 604 (and/or client organization 602) in accordance with relevant security policies.

An example of how architecture 600 might be used is as follows. A request for a record arrives at client organization 602. In response, security servers 604 transmit a related request to computational instance 606 that identifies the encrypted version of the record in encrypted records 608. Computational instance 606 then locates this encrypted version of the record and transmits it security servers 604. Security servers 604 is then able to decrypt the record using keys 604A, and use information in the record to carry out a further transaction.

TABLE 1

| Field | Plaintext | Ciphertext | Hash |
|---|---|---|---|
| Name | John Smith | kMgJDrggu509 | ef61a579c907 |
| Address | 123 Main St. | 3uYe3tyLeMeR | 2901e6deef79 |
| Email | jsmith@example.com | RYc9Eq6xZxP0 | 6e3913852f51 |
| Date of Birth | Apr. 30, 1975 | W7qbltS4HuIu | a62828567cd6 |

In order to facilitate the efficient retrieval of encrypted data records, each record (or field within a record) may be both encrypted and hashed. An example is shown in Table 1 for a simple record containing four fields: name, address, email, and date of birth. Each of these fields is assumed to be in textual form.

The first column in Table 1 contains the names of each field. In various implementations, this information would not be stored with each record, as it would be implicit from the database table or other data structure storing the record. The second column contains the plaintext (unencrypted) values of each field. This information also would not be stored with each record. The third column contains the ciphertext (encrypted) values of each field. The fourth column contains the hashed values of each field.

The ciphertext values may be generated using any appropriate encryption algorithm. These cryptosystems should have the property that corresponding plaintext cannot be derived from the ciphertext in a computationally tractable fashion without use of a predetermined key.

Thus, the encryption algorithm could be based on a symmetric cryptosystem, such as AES-256, RC6, ARIA, or CAST. In a symmetric cryptosystem, the same key is used to encrypt the plaintext to ciphertext, and to decrypt the ciphertext to plaintext. The encryption algorithm could alternatively be based on an asymmetric cryptosystem, such as RSA, ECC, ElGamal, or Cramer-Shoup. In an asymmetric cryptosystem, a pair of keys are mathematically linked such that ciphertext generated by applying one to the plaintext can only be decrypted by the other. Typically, one of these keys may be publicly known (the public key) and the other remains a secret (the private key).

In some embodiments, a hybrid cryptosystem could be used. For example, the plaintext could be converted to ciphertext using a symmetric cryptosystem. Then, the symmetric key used by this cryptosystem is encrypted by the public key of the intended recipient and stored with the ciphertext. In this fashion, only the intended recipient can decrypt the ciphertext—first by using its private key to decrypt the symmetric key and then using the symmetric key to decrypt the ciphertext. Security servers 604, for example, could use their own public key to encrypt information so that this information could only be decrypted with the corresponding private key.

Notably, the exact type of cryptosystem as well as the cryptographic algorithms used may vary. Thus, any of the aforementioned cryptosystems—or other cryptosystems known now or developed in the future—may be employed with the embodiments herein. For purposes of these embodiments, it will be assumed that a secure and robust cryptosystem is in place in security servers 604, and that security servers 604 provide the appropriate ciphertext to computational instance 606.

In order to look up encrypted records, the hashed values may be used. These values may be generated by applying a one-way hash function to the plaintext of the fields. Examples of one-way hash functions include SHA-3, Whirlpool, and RIPEMD-160, all having the property that it is computationally intractable to derive corresponding plaintext from the hashed output. In other words, for plaintext x and a one-way hash function H that produces the hash value y=H(x), there is no known inverse function H′ where x=H′(y).

Nonetheless, the property of a hash function not having a computable inverse is in practice sometimes insufficient to prevent determining these inverses. Many real-life semantic domains (e.g., the set of 9-digit social security numbers used in the U.S.) are small enough to allow the hash function to be evaluated over the whole domain (e.g., by way of exhaustive search). To prevent such an inversion, a hash-based message authentication code (HMAC) can be used. Such an HMAC uses cryptographic authentication with a hash function and a secret key rather than just the hash function. Use of the secret key makes computing inverses intractable.

Some embodiments may employ an order-preserving hash function G, that is a one-way function having the property G(x2)>G(x1) when x2>x1. This facilitates the lookup of records with fields that fall within a range of values. The hash value would contain integers reflecting a linear order on the hash function's domain.

In any event, encrypted records 608 may contain the ciphertext for each field, and hash values for at least some of the fields. As noted, the plaintext values and keys 604A are not provided to computational instance 606. For example, encrypted records 608 would only contain the two rightmost columns of Table 1.

Putting this all together, writing a record to encrypted records may take place as follows. For a record received at security servers 604, keys 604A are used to generate corresponding ciphertext for the plaintext of each field. Further, a hash function is used to generate corresponding hash values for the plaintext of any field that is intended to be used to look up records (this could be anywhere from none of the fields to all of the fields). Security servers 604 transmit the ciphertext and hash values to computational instance 606, and computational instance 606 stores these values in encrypted records 608.

Such a record stored in encrypted records 608 can be looked up as follows. It is assumed that the field by which the record is to be looked up has a corresponding hash value in encrypted records 608. Then, the plaintext of this value is hashed to its hash value, and the hash value is provided to computational instance 606. Computational instance 606 searches encrypted records 608 for this hash value appearing in the appropriate field, and transmits the encrypted record containing this value to security servers 606. Then, security servers 606 can use the appropriate key from keys 604A to decrypt the ciphertext values of each field of this record.

As a concrete example, consider the example record in Table 1. Suppose that a goal is to look up this record using the “Name” field. Thus, the plaintext “John Smith” is provided to security servers 604. Security servers 604 apply the hash function H to this plaintext, thereby generating the hash value “ef61a579c907”. This hash value is transmitted to computational instance 606, where it is used in a lookup process involving encrypted records 608. As a result of this process, the record with this hash value in the “Name” field is found. Then, computational instance 606 returns the ciphertext values in this record (i.e., “kMgJDrggu509”, “3uYe3tyLeMeR”, “RYc9Eq6xZxP0”, and “W7qbltS4HuIu”) to security servers 604. Security servers 604 can then use keys 604A to decrypt some or all of these ciphertext values, thereby deriving the plaintext version of the record for further processing.

In the case of a ranged lookup, such as for records with a “Date of Birth” field between two values, the lookup process may involve security servers providing hash values of a low end and a high end of the range to computational instance 606. Here it is assumed that an order-preserving hash function was used to produce hash values for the “Date of Birth” field based on a numeric representation thereof. Then, computational instance 606 may search for and return any records with hash values of the “Date of Birth” field that is between the hash values of the low end and the high end of the range. For instance, a low end of Apr. 1, 1975 and a high end of May 1, 1975 can be used to locate the record of Table 1. To perform the appropriate comparisons, dates may be stored in a numeric form, such as the number of seconds since some epoch (e.g., if the epoch of Jan. 1, 1900 is used, then Apr. 1, 1975 would have a value of 2377033200 assuming that seconds are rounded to the previous midnight for each date).

As another alternative, computational instance 606 may assign a timestamp to each encrypted record based on when it was received or most-recently updated. Then, all encrypted records written or updated within a range of time can be retrieved based on these timestamps. In this alternative, hash values are not required so long as the timestamps written by the computational instance accurately reflect the times of record creation or updating by a client device.

The following scenarios further illustrate how architecture 600 can be put into practice. Notably, these scenarios are not comprehensive and other scenarios may exist. Also, any acts attributed to client organization 602 or security servers 604 may be carried out by security servers 604 or other computing resources within or associated with client organization 602. Similarly, any acts attributed to computational instance 606 may be carried out computing resources dedicated to managing encrypted records 608 or other computing resources within or associated with computational instance 606.

A. Scenario: Remote Access to Encrypted Records

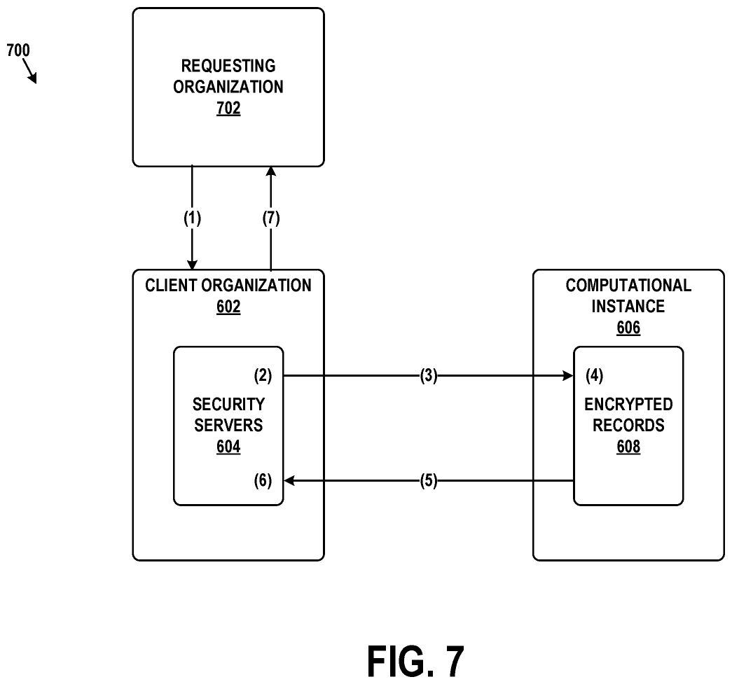

FIG. 7 depicts a scenario 700 for remote access to encrypted records 608. Herein, it is assumed that computational instance 606 stores some number of encrypted records on behalf of client organization 602. Thus, when requests for these records come from a requesting organization 702, it is desirable for client organization 602 to be able to provide the records in a rapid and accurate fashion.

At step (1), requesting organization 702 may transmit a request for one or more records to client organization 602. This request may identify keywords, phrases, or tokens appearing in plaintext versions of these records.

At step (2), security servers 604 may apply a hash function to the appropriate content of the request to generate a hash value. The hash function may be order-preserving as noted above.

At step (3), client organization 602 may transmit the hash value to computational instance 606.

At step (4), computational instance 606 may look up the received hash value in encrypted records 608. Any records with fields matching the received hash value may be identified.

At step (5), computational instance 606 may transmit the matching records to client organization 602. Notably, these records are still encrypted.

At step (6), security servers 604 may apply one or more of keys 604A (not shown in FIG. 7 for purposes of simplicity) in order to decrypt the matching records.

At step (7), client organization 602 may transmit the plaintext versions of the matching records to requesting organization 702.

In any of the transactions between entities (e.g., steps (1), (3), (5), and/or (7)), an additional layer of point to point encryption and/or authentication may be used to further protect the content of data transmitted over a public or private network, for example. This encryption and/or authentication may employ a symmetric cryptosystem, an asymmetric cryptosystem, or a hybrid cryptosystem.

In this scenario, client organization 602 can benefit from outsourcing the storage and management of encrypted records 608 to computational instance 606. In doing so, computational instance 606 cannot decrypt these records (because the decryption keys are maintained by client organization 602). Practical examples of this scenario include the transfer of electronic health records from one healthcare provider (client organization 602) to another healthcare provider (requesting organization 702). Other examples involve the transfer of HR records between organizations, or the selective backup of certain parts of a database.

B. Scenario: Logging of Transaction Data

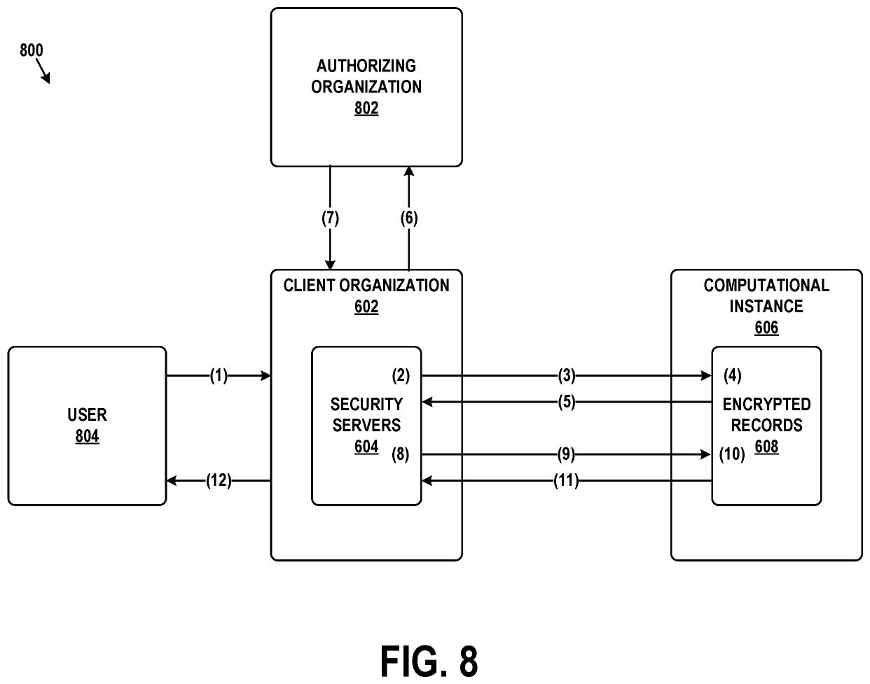

FIG. 8 depicts a scenario 800 for logging of transaction data to encrypted records 608. For example, authorizing organization 802 may contain one or more authorization servers that can grant or deny transactions initiated by user 804. Regardless of outcome, each transaction attempt and its result may be logged to encrypted records 608.

At step (1), user 804 may make a request to client organization 602. The request might be for authorization to conduct a transaction, and may include sensitive information relating to user 804 (or to some other user or entity).

At step (2), security servers 604 may encrypt information relating to the request, including the sensitive information, using keys 604A (not shown in FIG. 8 for purposes of simplicity). Some parts of this information may also be hashed so that records can be later be looked up. For purposes of the embodiments herein, hashing may involve use of a one-way function J(d, s)=w, e.g. HMAC(d, s)=w, with the following properties: (i) the confidential value d is replaced with the non confidential value w, and J may require a secret key s for the computation of w, (ii) given w and the function J, d cannot be computed by inverting J or by exhaustively searching J over all d.

At step (3), client organization 602 may transmit the encrypted information and the hashed information to computational instance 608. A unique transaction identifier may also be included in this transmission.

At step (4), computational instance 606 may store the encrypted information, the hashed information, and optionally the unique identifier as a record in encrypted records 608.

At step (5), computational instance 606 may transmit an acknowledgement to client organization 602.

At step (6), computational instance 606 may transmit an authorization request to authorizing organization 802. The authorization request may contain some of the sensitive information and may seek authorization to conduct the transaction. The authorization request may be transmitted in response to receiving the acknowledgment of step (5).

At step (7), authorizing organization 802 may transmit a result of the authorization request to client organization 602. This result may be that the request was authorized or that the request was denied.

At step (8), security servers 604 may encrypt information relating to the result with keys 604A. Some parts of this information may also be hashed so that records can be later be looked up.

At step (9), client organization 602 may transmit the encrypted information and the hashed information to computational instance 606. The result may be accompanied with enough other data (e.g., at least some of the sensitive information and/or the transaction identifier of step (3)) that can relate the result to the information stored in step (3).

At step (10), computational instance 606 may store the encrypted information, the hashed information, and optionally the transaction identifier as a record in encrypted records 608.

At step (11), computational instance 606 may transmit an acknowledgement to client organization 602.

At step (12), client organization 602 may transmit a representation of the result to user 804. In this way, user 804 may be informed of whether the transaction was successful. In some embodiments, step (12) may be performed at any point after step (7).

As was the case for scenario 700, in any of the transactions between entities (e.g., steps (1), (3), (5), (6), (7), (9), (11) and/or (12)), an additional layer of point to point encryption and/or authentication may be used to further protect the content of data transmitted over a public or private network, for example. This encryption and/or authentication may employ a symmetric cryptosystem, an asymmetric cryptosystem, or a hybrid cryptosystem.

In this scenario as well, client organization 602 can benefit from outsourcing the storage and management of encrypted records 608 to computational instance 606. Once more, computational instance 606 cannot decrypt these records (because the decryption keys are maintained by client organization 602). Practical examples of this scenario include payment transactions, such a credit or debit card authorizations. In these examples, client organization 602 may be an ecommerce web provider and authorizing organization 802 may be card issuer or a bank. But other types of non-financial, non-commercial transactions may be supported by scenario 800.

### VII. Example Operations

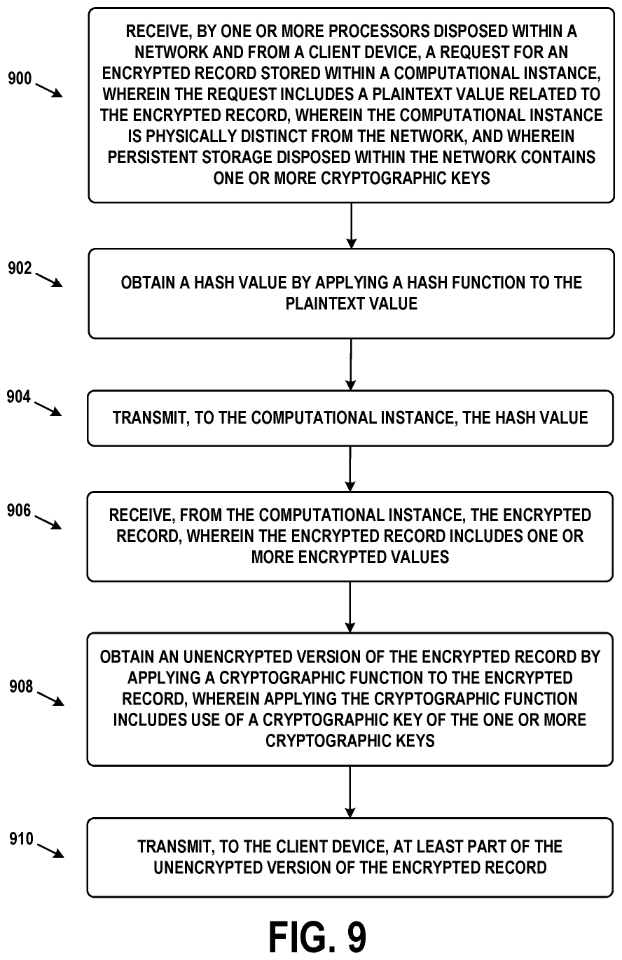

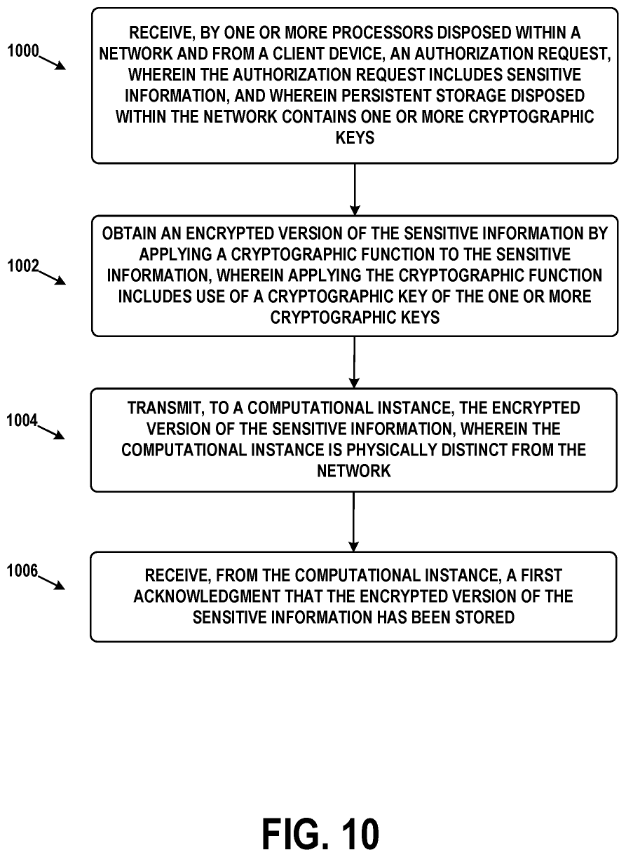

FIGS. 9 and 10 are flow charts illustrating example embodiments. The processes illustrated by FIGS. 9 and 10 may be carried out by a computing device, such as computing device 100, and/or a cluster of computing devices, such as server cluster 200. However, the process can be carried out by other types of devices or device subsystems. For example, the process could be carried out by one or more security servers within a managed network or another type of network.

The embodiments of FIGS. 9 and 10 may be simplified by the removal of any one or more of the features shown therein. Further, these embodiments may be combined with features, aspects, and/or implementations of any of the previous figures or otherwise described herein.

Block 900 of FIG. 9 may involve receiving, by one or more processors disposed within a network and from a client device, a request for an encrypted record stored within a computational instance, wherein the request includes a plaintext value related to the encrypted record, wherein the computational instance is physically distinct from the network, and wherein persistent storage disposed within the network contains one or more cryptographic keys.

Block 902 may involve obtaining a hash value by applying a hash function to the plaintext value.

Block 904 may involve transmitting, to the computational instance, the hash value.

Block 906 may involve receiving, from the computational instance, the encrypted record, wherein the encrypted record includes one or more encrypted values.

Block 908 may involve obtaining an unencrypted version of the encrypted record by applying a cryptographic function to the encrypted record, wherein applying the cryptographic function includes use of a cryptographic key of the one or more cryptographic keys.

Block 910 may involve transmitting, to the client device, at least part of the unencrypted version of the encrypted record.

In some embodiments, the computational instance stores a plurality of encrypted records, one of which being the encrypted record, wherein the encrypted records are respectively associated with hash values, and wherein the encrypted record is associated with the hash value.

In some embodiments, the encrypted record contains a set of encrypted values, wherein the hash value and one of the encrypted values were both derived from the plaintext value.

In some embodiments, the computational instance is configured to, in response to receiving the hash value: look up the hash value among the plurality of encrypted records; identify the encrypted record as being associated with the hash value; and transmit the encrypted record to the network.

In some embodiments, the cryptographic function is from a symmetric cryptosystem, wherein the encrypted record was created by the one or more processors applying the cryptographic function to the unencrypted version of the encrypted record.

In some embodiments, the cryptographic function is from an asymmetric cryptosystem, wherein the cryptographic key is a private key, wherein the encrypted record was created by the one or more processors applying an inverse of the cryptographic function to the unencrypted version of the encrypted record, and wherein applying the inverse of the cryptographic function includes use of a public key that is mathematically linked to the private key in accordance with the asymmetric cryptosystem.

In some embodiments, the computational instance does not have access to the one or more cryptographic keys.

In some embodiments, the one or more processors are further configured to perform operations comprising: receiving an authorization request, wherein the authorization request includes sensitive information; obtaining an encrypted version of the sensitive information by applying the cryptographic function to the sensitive information, wherein applying the cryptographic function includes use of the cryptographic key; transmitting, to the computational instance, the encrypted version of the sensitive information; and receiving, from the computational instance, a first acknowledgment that the encrypted version of the sensitive information has been stored.

In some embodiments, the one or more processors are further configured to perform operations comprising: transmitting, to an authorization server, a representation of the authorization request; receiving, from the authorization server, a result of the authorization request; obtaining an encrypted version of the result by applying the cryptographic function to the result, wherein applying the cryptographic function includes use of the cryptographic key; transmitting, to the computational instance, the encrypted version of the result; receiving, from the computational instance, a second acknowledgment that the encrypted version of the result has been stored; and providing, in response to the authorization request, the result.

In some embodiments, transmission and storage of the encrypted version of the sensitive information and transmission and storage of the encrypted version of the result are each accompanied by a unique identifier.

In some embodiments, transmission and storage of the encrypted version of the sensitive information and transmission and storage of the encrypted version of the result are each accompanied by a further hash value that was obtained by applying the hash function to at least part of the sensitive information.

In some embodiments, the result is either that the authorization request was authorized or that the authorization request was denied.

Block 1000 of FIG. 10 may involve receiving, by one or more processors disposed within a network and from a client device, an authorization request, wherein the authorization request includes sensitive information, and wherein persistent storage disposed within the network contains one or more cryptographic keys.

Block 1002 may involve obtaining an encrypted version of the sensitive information by applying a cryptographic function to the sensitive information, wherein applying the cryptographic function includes use of a cryptographic key of the one or more cryptographic keys.

Block 1004 may involve transmitting, to a computational instance, the encrypted version of the sensitive information, wherein the computational instance is physically distinct from the network.

Block 1006 may involve receiving, from the computational instance, a first acknowledgment that the encrypted version of the sensitive information has been stored.

Some embodiments may further involve: transmitting, to an authorization server, a representation of the authorization request; receiving, from the authorization server, a result of the authorization request; obtaining an encrypted version of the result by applying the cryptographic function to the result, wherein applying the cryptographic function includes use of the cryptographic key; transmitting, to the computational instance, the encrypted version of the result; receiving, from the computational instance, a second acknowledgment that the encrypted version of the result has been stored; and providing, in response to the authorization request, the result.

In some embodiments, transmission and storage of the encrypted version of the sensitive information and transmission and storage of the encrypted version of the result are each accompanied by a unique identifier.

In some embodiments, transmission and storage of the encrypted version of the sensitive information and transmission and storage of the encrypted version of the result are each accompanied by a further hash value that was obtained by applying the hash function to at least part of the sensitive information.

In some embodiments, the result is either that the authorization request was authorized or that the authorization request was denied.

### VIII. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid-state drive, or another storage medium.

The computer readable medium can also include non-transitory computer readable media such as non-transitory computer readable media that store data for short periods of time like register memory and processor cache. The non-transitory computer readable media can further include non-transitory computer readable media that store program code and/or data for longer periods of time. Thus, the non-transitory computer readable media may include secondary or persistent long-term storage, like ROM, optical or magnetic disks, solid-state drives, or compact disc read only memory (CD-ROM), for example. The non-transitory computer readable media can also be any other volatile or non-volatile storage systems. A non-transitory computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A system comprising:
persistent storage disposed within a network and containing one or more cryptographic keys; and
one or more processors disposed within the network and configured to perform operations comprising:
receiving, from a client device, a request for an encrypted record stored within a computational instance, wherein the request includes a plaintext value related to the encrypted record, and wherein the computational instance is physically distinct from the network;
obtaining a hash value by applying a hash function to the plaintext value;
transmitting, to the computational instance, the hash value;
receiving, from the computational instance, the encrypted record, wherein the encrypted record includes one or more encrypted values;
obtaining an unencrypted version of the encrypted record by applying a cryptographic function to the encrypted record, wherein applying the cryptographic function includes use of a cryptographic key of the one or more cryptographic keys; and
transmitting, to the client device, at least part of the unencrypted version of the encrypted record.

2. The system of claim 1, wherein the computational instance stores a plurality of encrypted records, one of which being the encrypted record, wherein the encrypted records are respectively associated with hash values, and wherein the encrypted record is associated with the hash value.

3. The system of claim 2, wherein the encrypted record contains a set of encrypted values, and wherein the hash value and one of the encrypted values were both derived from the plaintext value.

4. The system of claim 2, wherein the computational instance is configured to, in response to receiving the hash value:
look up the hash value among the plurality of encrypted records;
identify the encrypted record as being associated with the hash value; and
transmit the encrypted record to the network.

5. The system of claim 1, wherein the cryptographic function is from a symmetric cryptosystem, and wherein the encrypted record was created by the one or more processors applying the cryptographic function to the unencrypted version of the encrypted record.

6. The system of claim 1, wherein the cryptographic function is from an asymmetric cryptosystem, wherein the cryptographic key is a private key, wherein the encrypted record was created by the one or more processors applying an inverse of the cryptographic function to the unencrypted version of the encrypted record, and wherein applying the inverse of the cryptographic function includes use of a public key that is mathematically linked to the private key in accordance with the asymmetric cryptosystem.

7. The system of claim 1, wherein the computational instance does not have access to the one or more cryptographic keys.

8. The system of claim 1, wherein the one or more processors are further configured to perform operations comprising:
receiving an authorization request, wherein the authorization request includes sensitive information;
obtaining an encrypted version of the sensitive information by applying the cryptographic function to the sensitive information, wherein applying the cryptographic function includes use of the cryptographic key;
transmitting, to the computational instance, the encrypted version of the sensitive information; and
receiving, from the computational instance, a first acknowledgment that the encrypted version of the sensitive information has been stored.

9. The system of claim 8, wherein the one or more processors are further configured to perform operations comprising:
transmitting, to an authorization server, a representation of the authorization request;
receiving, from the authorization server, a result of the authorization request;
obtaining an encrypted version of the result by applying the cryptographic function to the result, wherein applying the cryptographic function includes use of the cryptographic key;
transmitting, to the computational instance, the encrypted version of the result;
receiving, from the computational instance, a second acknowledgment that the encrypted version of the result has been stored; and
providing, in response to the authorization request, the result.

10. The system of claim 9, wherein transmission and storage of the encrypted version of the sensitive information and transmission and storage of the encrypted version of the result are each accompanied by a unique identifier.

11. The system of claim 9, wherein transmission and storage of the encrypted version of the sensitive information and transmission and storage of the encrypted version of the result are each accompanied by a further hash value that was obtained by applying the hash function to at least part of the sensitive information.

12. The system of claim 9, wherein the result is either that the authorization request was authorized or that the authorization request was denied.

13. A system comprising:
persistent storage disposed within a network and containing one or more cryptographic keys; and
one or more processors disposed within the network and configured to perform operations comprising:
receiving, from a client device, an authorization request, wherein the authorization request includes sensitive information;
obtaining an encrypted version of the sensitive information by applying a cryptographic function to the sensitive information, wherein applying the cryptographic function includes use of a cryptographic key of the one or more cryptographic keys;
transmitting, to a computational instance, the encrypted version of the sensitive information, wherein the computational instance is physically distinct from the network; and
receiving, from the computational instance, a first acknowledgment that the encrypted version of the sensitive information has been stored.

14. The system of claim 13, wherein the one or more processors are further configured to perform operations comprising:
transmitting, to an authorization server, a representation of the authorization request;
receiving, from the authorization server, a result of the authorization request;
obtaining an encrypted version of the result by applying the cryptographic function to the result, wherein applying the cryptographic function includes use of the cryptographic key;
transmitting, to the computational instance, the encrypted version of the result;
receiving, from the computational instance, a second acknowledgment that the encrypted version of the result has been stored; and
providing, in response to the authorization request, the result.

15. A computer-implemented method comprising:
receiving, by one or more processors disposed within a network and from a client device, a request for an encrypted record stored within a computational instance, wherein the request includes a plaintext value related to the encrypted record, wherein the computational instance is physically distinct from the network, and wherein persistent storage disposed within the network contains one or more cryptographic keys;
obtaining a hash value by applying a hash function to the plaintext value;
transmitting, to the computational instance, the hash value;
receiving, from the computational instance, the encrypted record, wherein the encrypted record includes one or more encrypted values;
obtaining an unencrypted version of the encrypted record by applying a cryptographic function to the encrypted record, wherein applying the cryptographic function includes use of a cryptographic key of the one or more cryptographic keys; and
transmitting, to the client device, at least part of the unencrypted version of the encrypted record.

16. The computer-implemented method of claim 15, wherein the computational instance stores a plurality of encrypted records, one of which being the encrypted record, wherein the encrypted records are respectively associated with hash values, and wherein the encrypted record is associated with the hash value.

17. The computer-implemented method of claim 16, wherein the encrypted record contains a set of encrypted values, and wherein the hash value and one of the encrypted values were both derived from the plaintext value.

18. The computer-implemented method of claim 16, wherein the computational instance is configured to, in response to receiving the hash value:
look up the hash value among the plurality of encrypted records;
identify the encrypted record as being associated with the hash value; and
transmit the encrypted record to the network.

19. The computer-implemented method of claim 15, further comprising:
receiving an authorization request, wherein the authorization request includes sensitive information;
obtaining an encrypted version of the sensitive information by applying the cryptographic function to the sensitive information, wherein applying the cryptographic function includes use of the cryptographic key;
transmitting, to the computational instance, the encrypted version of the sensitive information; and
receiving, from the computational instance, a first acknowledgment that the encrypted version of the sensitive information has been stored.

20. The computer-implemented method of claim 19, further comprising:
transmitting, to an authorization server, a representation of the authorization request;
receiving, from the authorization server, a result of the authorization request;
obtaining an encrypted version of the result by applying the cryptographic function to the result, wherein applying the cryptographic function includes use of the cryptographic key;
transmitting, to the computational instance, the encrypted version of the result;
receiving, from the computational instance, a second acknowledgment that the encrypted version of the result has been stored; and
providing, in response to the authorization request, the result.
